(19) United States
(12) Patent Application Publication
(10) Pub. No.: US 2026/0367017 A1
(43) Pub. Date: Nov. 19, 2026

(54) Material Concentration Detection Method and Material Concentration Detection System

(71) Applicant: Advanced Comm. Engineering Solution Co., Ltd., Hsinchu County (TW)

(72) Inventors: Yu-Sheng Chen, Hsinchu County (TW); Ying-Kuan Ko, Hsinchu County (TW); Yung-Chou Hsu, Hsinchu County (TW); Chia-Wei Chang, Hsinchu County (TW); Hui-Shun Kuan, Hsinchu County (TW); Chan-Shan Yang, Hsinchu County (TW); Shen-Fu Hsu, Hsinchu County (TW)

(73) Assignee: Advanced Comm. Engineering Solution Co., Ltd., Hsinchu County (TW)

(21) Appl. No.: 19/752,623

(22) Filed: Jul. 24, 2026

Related U.S. Application Data
(63) Continuation-in-part of application No. 18/813,045, filed on Aug. 23, 2024, now Pat. No. 12,754,142.

(30) Foreign Application Priority Data
Jun. 6, 2024 (TW) 113121047
Feb. 24, 2026 (TW) 115106533

(51) Int. Cl. G01N 22/00; G01N 27/60

(52) U.S. Cl. CPC G01N 22/00; G01N 27/60

(57) ABSTRACT

A material concentration detection method includes generating an emission electromagnetic wave and directing the emission electromagnetic wave to be incident upon a material, wherein the material comprises at least one of a solid, a powder, a liquid, or a gas; detecting a plurality of receiving electromagnetic waves reflected, transmitted, or scattered after the emission electromagnetic wave is incident upon the material; measuring a plurality of characteristic signals based on the emission electromagnetic wave and the plurality of receiving electromagnetic waves; and analyzing the plurality of characteristic signals to determine a concentration characteristic of the material; wherein the step of analyzing the plurality of characteristic signals comprises utilizing intensity attenuation or absorption characteristics in the plurality of characteristic signals to calculate the concentration characteristic according to the Beer-Lambert law or an analogous form of the Beer-Lambert law in a reflection or scattering mode.

### CROSS REFERENCE TO RELATED APPLICATIONS

This application is a continuation-in-part of U.S. Application No. 18/813,045, filed on Aug. 23rd, 2024. The content of the application is incorporated herein by reference.

### BACKGROUND OF THE INVENTION

### 1. Field of the Invention

The present invention relates to a material concentration detection method and a material concentration detection system, and more particularly, to a non-contact and non-destructive material concentration detection method and material concentration detection system.

### 2. Description of the Prior Art

In the fields of materials science and chemical engineering, accurate measurement of the concentration of solids, powders, liquids, and gases is an important part of studying material properties, process control, and product quality. Conventional concentration measurement methods mainly include gravimetric methods, titration and chemical analysis, sensor conductivity measurement, and gas chromatography/mass spectrometry. However, these methods usually have limitations such as cumbersome sample pretreatment, the need to destroy or dissolve the sample, slow measurement speed, and the inability to obtain spatial distribution information. For example, in powder or solid samples, conventional gravimetric or chemical titration methods require grinding or dissolving the powder and cannot monitor concentration changes in real time; if the sample is buried in other materials, direct measurement is also impossible. In gas or liquid samples, conventional chemical analysis methods may require long sampling times or standard solutions and are susceptible to interference from impurities. These shortcomings make conventional methods difficult to apply to continuous process monitoring or non-destructive inspection, especially in opaque materials or multilayer structures, where internal concentration distribution or local changes cannot be effectively detected.

To overcome some of the limitations of conventional methods, the applicant has proposed various detection technologies. For example, U.S. Patent Application No. 18/813,045 discloses a composite structure detecting method and system that utilizes terahertz electromagnetic waves to detect characteristics of a plurality of interface layers of a composite structure, such as thickness, optical coefficients, electrical coefficients, dielectric constants, and structural defects. The technology is suitable for non-destructive inspection of composite structures such as silicon photonics or printed circuit boards. However, this technology mainly focuses on structural integrity and defect detection and has not been optimized for quantitative analysis of material concentration.

Similarly, U.S. Patent Application No. 18/885,738 discloses a layered detection method and layered detection system that utilizes terahertz electromagnetic waves to perform layered analysis on solid materials to determine internal defect information, such as material purity inhomogeneity, porosity, or residual stress. The technology is suitable for internal structural evaluation of semiconductor wafers, ceramics, or polymer materials. Although the technology can divide a solid material into a plurality of parallel layers and analyze its electrical and optical coefficients, its design purpose is defect detection and uniformity judgment. It does not integrate a quantitative calculation model related to concentration and therefore cannot be simply adapted for concentration detection of liquids, gases, or powder materials, especially in scenarios requiring real-time monitoring of concentration changes or generation of concentration distribution maps.

Therefore, there is a need to improve the prior art.

### SUMMARY OF THE INVENTION

To solve the above problems, the present invention provides a material concentration detection method and a material concentration detection system.

The present invention provides a material concentration detection method, which comprises generating an emission electromagnetic wave and directing the emission electromagnetic wave to be incident upon a material, wherein the material comprises at least one of a solid, a powder, a liquid, or a gas; detecting a plurality of receiving electromagnetic waves reflected, transmitted, or scattered after the emission electromagnetic wave is incident upon the material; measuring a plurality of characteristic signals based on the emission electromagnetic wave and the plurality of receiving electromagnetic waves; and analyzing the plurality of characteristic signals to determine a concentration characteristic of the material; wherein the step of analyzing the plurality of characteristic signals comprises utilizing intensity attenuation or absorption characteristics in the plurality of characteristic signals to calculate the concentration characteristic according to the Beer-Lambert law or an analogous form of the Beer-Lambert law in a reflection or scattering mode.

The present invention further provides A material concentration detection system, which comprises an electromagnetic wave generator, configured to generate an emission electromagnetic wave and direct the emission electromagnetic wave to be incident upon a material, wherein the material comprises at least one of a solid, a powder, a liquid, or a gas; an electromagnetic wave receiver, configured to detect a plurality of receiving electromagnetic waves reflected, transmitted, or scattered after the emission electromagnetic wave is incident upon the material; and a detection device, coupled to the electromagnetic wave generator and the electromagnetic wave receiver, configured to measure a plurality of characteristic signals based on the emission electromagnetic wave and the plurality of receiving electromagnetic waves, and to analyze the plurality of characteristic signals to determine a concentration characteristic of the material; wherein the step of analyzing the plurality of characteristic signals comprises utilizing intensity attenuation or absorption characteristics in the plurality of characteristic signals to calculate the concentration characteristic according to the Beer-Lambert law or an analogous form of the Beer-Lambert law in a reflection or scattering mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a material concentration detection system according to an embodiment of the present invention.

FIGS. 2 and 3 are schematic diagrams of time-domain and frequency-domain optical spectra detected by the emission electromagnetic wave, respectively.

FIGS. 4 and 5 are schematic diagrams of material concentration detection systems according to embodiments of the present invention.

FIG. 6 is a schematic diagram of a material concentration detection process according to an embodiment of the present invention.

### DETAILED DESCRIPTION

Certain terms are used throughout the description and following claims to refer to particular components. As one skilled in the art will appreciate, hardware manufacturers may refer to a component by different names. This specification and the claims do not intend to distinguish between components that differ in name but not in function; rather, components are distinguished based on differences in function. The terms “comprise” and “include” used in the specification and claims are open-ended terms and should be interpreted as “include, but not limited to.” “Substantially” means within an acceptable error range, and one skilled in the art can solve the technical problem within a certain error range and basically achieve the technical effect. In addition, the term “coupled” herein includes any direct and indirect, wired and wireless connection means.

To effectively detect material concentration, and in particular to perform non-contact and non-destructive concentration detection on materials such as solids, powders, liquids, or gases, the present invention employs electromagnetic waves in the frequency range between 10¹⁰ Hz and 10¹⁴ Hz for detection. This frequency range includes the terahertz (Terahertz Wave) band, which can penetrate non-conductors and measure highly water-containing substances. The advantages of detection in this band are that it has penetrability for many materials and can detect optical coefficients, electrical properties, layer thickness, or structural defects for different materials and structures within a plate; it can also be used for technical inspection in manufacturing processes, and inspection of semi-finished or finished products. When materials are inspected with electromagnetic waves in the above frequency range, because the frequency of the electromagnetic waves is much lower than that of infrared electromagnetic waves, the photon energy carried is smaller, so the molecular structure will not be destroyed, thereby maintaining the integrity of the material and preventing further expansion of damage or defects. Therefore, the present invention can be applied to fields such as powder mixtures, opaque materials, solution concentration, and gas distribution.

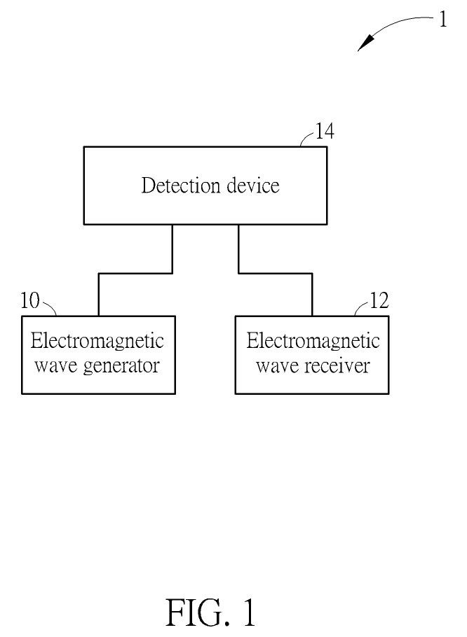

Specifically, please refer to FIG. 1. FIG. 1 is a functional block diagram of a material concentration detection system 1 according to an embodiment of the present invention. The material concentration detection system 1 includes an electromagnetic wave generator 10, an electromagnetic wave receiver 12, and a detection device 14, which can detect a concentration characteristic of a material, wherein the material may comprise at least one of a solid, a powder, a liquid, or a gas. The electromagnetic wave generator 10 is configured to generate an emission electromagnetic wave and direct it to be incident upon the material. The electromagnetic wave receiver 12 is configured to detect a plurality of receiving electromagnetic waves reflected, transmitted, or scattered after the emission electromagnetic wave is incident upon the material. The detection device 14 is coupled to the electromagnetic wave generator 10 and the electromagnetic wave receiver 12, and is configured to measure a plurality of characteristic signals based on the emission electromagnetic wave and the plurality of receiving electromagnetic waves, and to analyze the plurality of characteristic signals to determine the concentration characteristic or other characteristics of the material. Accordingly, the detection device 14 can further determine the concentration distribution, uniformity, or presence of defects in the material, or provide a user with a basis for determining whether defects exist; the defects may include inhomogeneity, impurities, voids, and the like.

In the material concentration detection system 1, the electromagnetic wave generator 10 is used to generate the emission electromagnetic wave. The generation method is not limited to a specific structure and may include linear polarization, circular polarization, or elliptical polarization, but is not limited thereto. In one embodiment, the electromagnetic wave generator 10 may be composed of a titanium sapphire femtosecond laser generator and optical elements. The titanium sapphire femtosecond laser generator generates a pulsed infrared beam with a center wavelength of 800 nm, a pulse repetition rate of 76 MHz, and an output power of 1.1 W. The pulsed infrared beam is focused by the optical elements to form the emission electromagnetic wave, whose frequency range is 10¹⁰ Hz to 10¹⁴ Hz.

In one embodiment, the emission electromagnetic wave generated by the electromagnetic wave generator 10 may be further output to the detection device 14 via a beam splitter and a delay device, so that the detection device 14 can measure the plurality of characteristic signals according to the receiving electromagnetic waves received by the electromagnetic wave receiver 12 and the emission electromagnetic wave generated by the electromagnetic wave generator 10 (that has not passed through the material). Alternatively, in another embodiment, the detection device 14 may separately measure the plurality of characteristic signals according to the receiving electromagnetic waves when no material to be tested is provided and when the material to be tested is provided. That is, the detection device 14 measures the plurality of characteristic signals according to the signal of the emission electromagnetic wave detecting air and the signal of detecting the material. The signal of the emission electromagnetic wave detecting air may be obtained from the emission electromagnetic wave generated by the electromagnetic wave generator 10 via the beam splitter and the delay device, or may be the receiving electromagnetic wave when no material to be tested is present, and is not limited thereto.

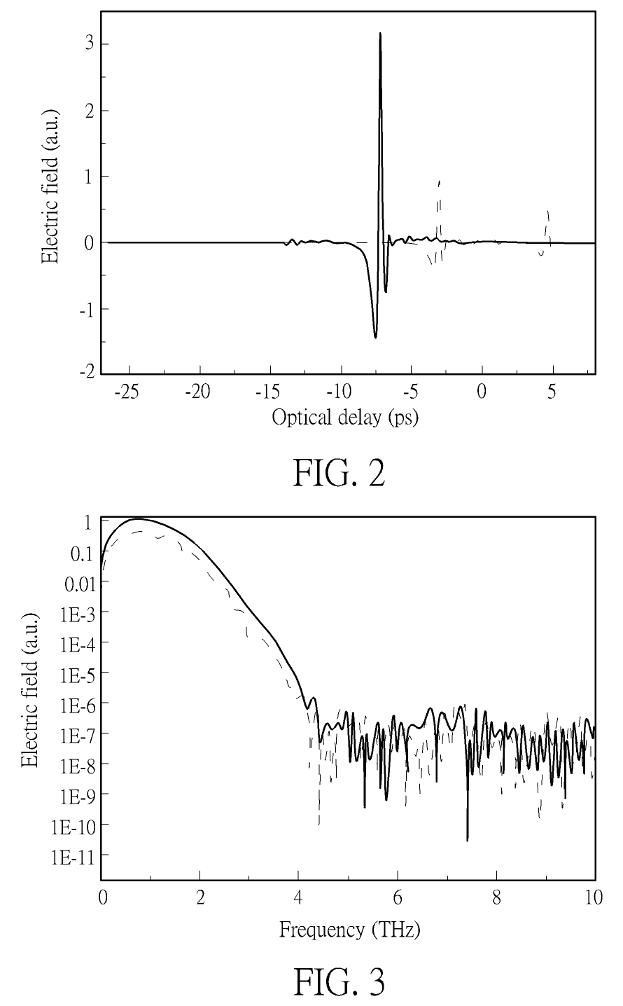

Further, the detection device 14 can compare the signal of the emission electromagnetic wave detecting air with the signal of detecting the material, and analyze the time-domain optical spectrum and the frequency-domain optical spectrum to measure the characteristic signals. For example, please refer to FIGS. 2 and 3. FIGS. 2 and 3 are schematic diagrams of the time-domain optical spectrum and the frequency-domain optical spectrum detected by the emission electromagnetic wave, respectively. In FIG. 2, the solid line represents the result of the electric field versus optical delay when the emission electromagnetic wave detects air (without the material to be tested) in the time-domain optical spectrum, and the dashed line represents the result of the electric field versus optical delay when the emission electromagnetic wave detects the material. In FIG. 3, the solid line represents the result of the electric field versus frequency when the emission electromagnetic wave detects air in the frequency-domain optical spectrum, and the dashed line represents the result of the electric field versus frequency when the emission electromagnetic wave detects the material. Therefore, by analyzing the time-domain optical spectrum and the frequency-domain optical spectrum, the detection device 14 can measure the characteristic signals, and further analyze and obtain the refractive index, dielectric constant, conductivity, absorption coefficient, and other coefficients of the material, and can analyze the internal structure of the material and whether defects exist or provide a basis for determining defects. The defects may include material purity inhomogeneity (such as bubbles or uneven mixing of multiple materials), lattice dislocations, uneven doping concentration, and the like. Specifically, the detection device 14 can measure a transient electric field of each receiving electromagnetic wave in the time domain to obtain an electric field intensity and an electric field phase of the transient (time-domain) electric field, and can measure a spectral electric field between the receiving electromagnetic waves in the frequency domain to obtain an electric field amplitude and an electric field phase of the spectral electric field. That is, the characteristic signals measured by the detection device 14 may include the transient electric field intensity and phase of each receiving electromagnetic wave in the time domain, and the spectral electric field amplitude and phase between the receiving electromagnetic waves in the frequency domain. Since the characteristic signals (transient electric field intensity and phase, spectral electric field amplitude and phase) are very sensitive to material properties, through transformation (such as Fourier transform), the dielectric constant of the material can be directly measured, and the optical coefficients of the material (such as absorptance, refractive index, reflectance, or transmittance) and electrical coefficients (such as conductivity, doping concentration, or charge carrier mobility) as well as resistance and structural characteristics can also be derived. On the other hand, the detection device 14 can measure the time of flight of the plurality of receiving electromagnetic waves and analyze the time of flight to determine the thickness of the material. In this way, the detection device 14 can analyze whether the material structure is abnormal, whether the thickness matches the design, whether there is stress change, and the like based on the time-domain time-of-flight spectrum signal, and can also be used to determine whether there is an error in the process technology or whether the component is defective.

In the present invention, the detection device 14 can further utilize the intensity attenuation or absorption characteristics in the plurality of characteristic signals to calculate the concentration characteristic according to the Beer-Lambert law or its analogous form in reflection or scattering mode. The Beer-Lambert law describes the relationship between absorbance (A) and material concentration (C). Its classic form is A = -log₁₀ (Iₜ / I₀) = α × d × C, where I₀ is the intensity of the incident electromagnetic wave, Iₜ is the intensity of the receiving electromagnetic wave after passing through the material, α is the absorption coefficient, and d is the material thickness. In transmission mode, the transmitted signal intensity can be used directly. In reflection or scattering mode, the corresponding or analogous calculation can be performed through the reflectance or the drop in scattering intensity to establish the correspondence between concentration and signal variation. The application of this law enables the present invention to perform quantitative concentration analysis on materials, and is particularly suitable for component ratio detection in powder mixtures, liquid solution concentration monitoring, or gas distribution analysis.

Therefore, by comparing the signal of the emission electromagnetic wave detecting air with the signal of detecting the material, the detection device 14 can measure the plurality of characteristic signals related to the material, and thereby determine the concentration characteristic or other characteristics of the material. The characteristic signals may include the electric field intensity and electric field phase of the time-domain electric field of each receiving electromagnetic wave and/or the electric field amplitude and electric field phase of the spectral electric field between the receiving electromagnetic waves. The other characteristics may include the refractive index, absorption coefficient, scattering coefficient, dielectric constant, conductivity, moisture content, component ratio, or impurity concentration of the material. Accordingly, the detection device 14 can further determine whether the material contains defects or provide a basis for determining defects.

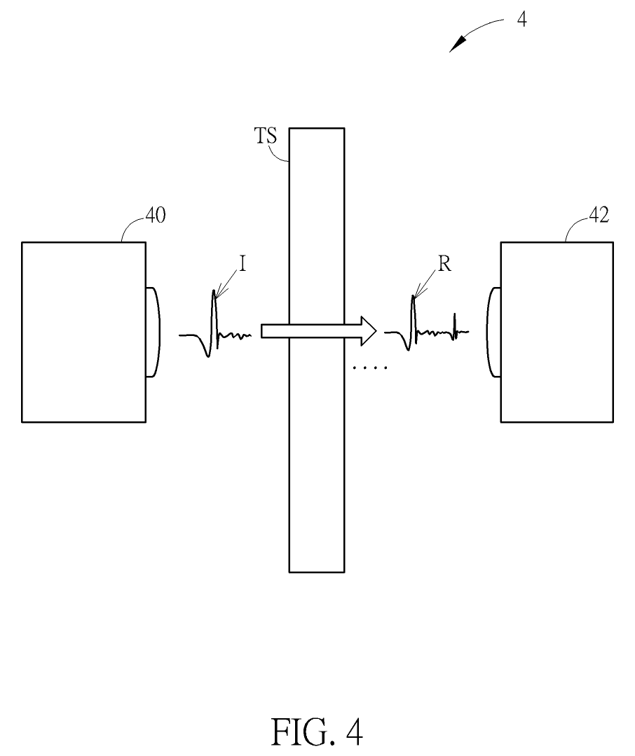

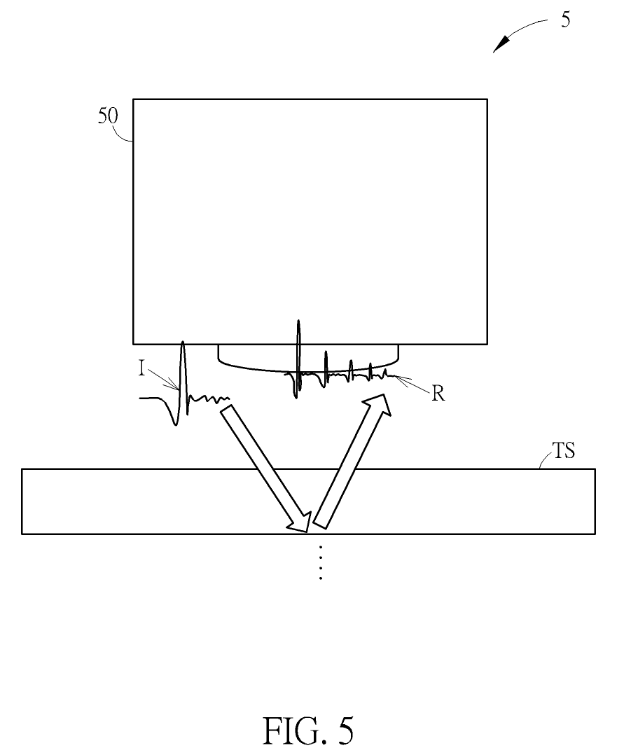

It should be noted that the material concentration detection system 1 in FIG. 1 is illustrated with functional blocks to represent the essential components of the embodiment of the present invention. However, when implementing the material concentration detection system 1, one skilled in the art can design or select an appropriate architecture according to actual requirements. For example, please refer to FIGS. 4 and 5. FIGS. 4 and 5 are schematic diagrams of material concentration detection systems 4 and 5 according to embodiments of the present invention, respectively. The material concentration detection systems 4 and 5 are derived from the material concentration detection system 1 and respectively adopt transmission-type and reflection-type electromagnetic wave detection architectures. For brevity, FIGS. 4 and 5 omit the relevant position of the detection device 14, which one skilled in the art can understand from FIG. 1. In detail, the material concentration detection system 4 generates an emission electromagnetic wave I through an electromagnetic wave generator 40, which is incident upon a test object TS (such as the material), and an electromagnetic wave receiver 42 detects a receiving electromagnetic wave R transmitted after the emission electromagnetic wave I is incident upon the test object TS. On the other hand, the material concentration detection system 5 adopts a reflection-type detection architecture, in which an electromagnetic wave generator and receiver 50 integrates the functions of electromagnetic wave emission and reception. That is, the electromagnetic wave generator and receiver 50 can generate an emission electromagnetic wave I, direct the emission electromagnetic wave I to be incident upon the test object TS (such as the material), and detect a receiving electromagnetic wave R reflected after the emission electromagnetic wave I is incident upon the test object TS. In addition, the operation of the material concentration detection systems 4 and 5 can refer to the aforementioned operation of the material concentration detection system 1. That is, the detection device (not shown in FIGS. 4 and 5) can analyze the time-domain optical spectrum and the frequency-domain optical spectrum based on the emission electromagnetic wave I (that has not passed through the test object TS) and the receiving electromagnetic wave R (that has passed through the test object TS), measure a plurality of characteristic signals, and thereby analyze and obtain the material concentration characteristic of the test object TS, and can analyze the internal structure of the test object TS and whether defects exist or provide a basis for determining defects.

It should be noted that the material concentration detection systems 4 and 5 are transmission-type and reflection-type electromagnetic wave detection architectures derived from the material concentration detection system 1. One skilled in the art should adopt an appropriate architecture according to actual requirements or the items to be detected, and the present invention is not limited thereto. Generally speaking, the transmission-type electromagnetic wave detection architecture can directly penetrate the material to obtain information on the overall signal phase difference and signal intensity drop; while the reflection-type electromagnetic wave detection architecture reflects a signal when penetrating the material, so it returns one or a plurality of electromagnetic waves. From these signals, the structural plane distribution and thickness variation of the material, as well as its material parameters such as refractive index, dielectric constant, conductivity, and absorption coefficient can be analyzed.

In addition, the embodiments of the present invention are applicable to the detection of various materials, such as powder mixtures, solid samples, liquid samples, or gas samples. Taking a powder mixture as an example, the component concentration and uniformity need to be monitored during the process. The embodiments of the present invention can perform single-point detection on the powder to obtain results similar to those shown in FIGS. 2 and 3; alternatively, the detection area can be a specific area, and scanning-mode detection can be performed by moving the detector or the sample stage. When detecting materials, especially solid samples, the technology disclosed in U.S. Patent Application No. 18/813,045 can also be used in the present invention. For example, the material concentration characteristic can be detected first, and then the composite structure can be detected, or the material concentration characteristic and the composite structure can be detected simultaneously; both fall within the scope of the present invention. The technology of U.S. Patent Application No. 18/813,045 mainly targets composite structures or multilayer materials and performs non-destructive detection using electromagnetic waves (including the terahertz band). By performing C-Scan planar scanning and B-Scan cross-sectional scanning on the test object, the spatial distribution and depth variation of the characteristic signals are analyzed. The C-Scan planar scan can generate a two-dimensional signal image of the material at a specific depth or a specific layer, which is used to observe the concentration uniformity within the plane, local concentration anomalies, or impurity distribution. The B-Scan cross-sectional scan provides a cross-sectional signal image along the depth direction, which can clearly show the concentration gradient between layers, interface concentration changes, or intra-layer inhomogeneity in multilayer materials. In applications involving multilayer materials (such as multilayer powder-pressed structures, coated solids, or liquid layered systems), the C-Scan can quickly identify regions of concentration inhomogeneity within the plane, while the B-Scan helps accurately locate which layer or which interface has a concentration anomaly. When the material has defects (such as concentration inhomogeneity, bubble entrapment, or component separation), the C-Scan or B-Scan detection results will show local discontinuity or abnormal changes in signal intensity or phase, thereby determining whether the concentration is incorrect, whether the material is uniform, or whether there are impurities or other defects. Therefore, through the application of this technology, inspectors can eliminate defective products, and researchers can determine the causes of defective products, such as uneven component mixing, residual impurities, inter-layer diffusion, or process parameter deviation.

Similarly, the embodiments of the present invention can also adopt the layered detection technology disclosed in U.S. Patent Application No. 18/885,738 to divide the material into a plurality of parallel layers along the depth direction (first direction) and analyze the concentration characteristic of each layer. Although the technology was originally used for internal layered defect detection of solid materials, it can be extended in the present invention to multilayer materials, powder compacts, liquid layered systems, or gas mixing regions. For example, when detecting multilayer solid materials, the thickness of each layer (such as a surface layer of 10 μm and an intermediate layer of 50 μm) can be set, and the absorption coefficient, refractive index, or concentration value of each layer can be calculated separately to generate a concentration distribution map for each layer. For liquid samples (such as solution layering or emulsions), the solute concentration gradient at different depth layers can be analyzed. For gas samples (such as gas mixing chambers), the component concentration distribution in different regions can be distinguished. Through this layered analysis, the internal concentration inhomogeneity, component ratio deviation, local concentration or dilution regions, and even hierarchical changes in moisture content, impurity concentration, or reaction product distribution of the material can be determined more accurately. In this way, the present invention can not only provide overall concentration information but also reveal the concentration heterogeneity in the depth direction, which is helpful for process optimization and quality control.

For example, in one embodiment, if the test object is a multilayer coating structure (such as multilayer dielectric layers or powder coating layers in a semiconductor process), the present invention can utilize a reflection-type or transmission-type architecture, combined with C-Scan and B-Scan scanning, to monitor whether the material concentration of each coating meets the design value and to detect whether inter-layer concentration penetration or inhomogeneity occurs due to process variation. In another embodiment, if the test object is a liquid solution (such as a pharmaceutical formulation or chemical reaction liquid), the present invention can perform non-contact detection through a transparent or translucent container to analyze the overall concentration of the solution and whether precipitation, layering, or concentration gradients exist. In yet another embodiment, if the test object is a gas mixture (such as industrial exhaust gas or ambient gas), the present invention can utilize a gas cell or open-path detection to monitor the concentration distribution and time-varying characteristics of specific gas components (such as moisture, ammonia, or volatile organic compounds).

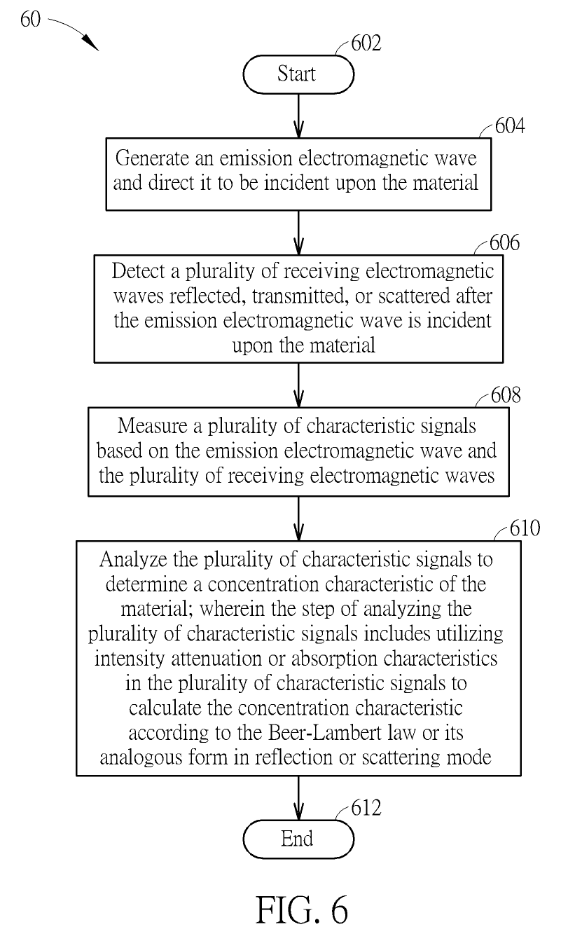

The operation methods of the material concentration detection systems 1, 4, and 5 described above can be summarized into a material concentration detection process 60, as shown in FIG. 6. The material concentration detection process 60 is used to detect a material, wherein the material comprises at least one of a solid, a powder, a liquid, or a gas. The material concentration detection process 60 includes the following steps:

Step 602: Start.

Step 604: Generate an emission electromagnetic wave and direct it to be incident upon the material.

Step 606: Detect a plurality of receiving electromagnetic waves reflected, transmitted, or scattered after the emission electromagnetic wave is incident upon the material.

Step 608: Measure a plurality of characteristic signals based on the emission electromagnetic wave and the plurality of receiving electromagnetic waves.

Step 610: Analyze the plurality of characteristic signals to determine a concentration characteristic of the material; wherein the step of analyzing the plurality of characteristic signals includes utilizing intensity attenuation or absorption characteristics in the plurality of characteristic signals to calculate the concentration characteristic according to the Beer-Lambert law or its analogous form in reflection or scattering mode.

Step 612: End.

For the detailed operation and variations of the material concentration detection process 60, please refer to the foregoing description, which will not be repeated here.

In the prior art, conventional concentration detection methods require destruction of the sample or cannot perform real-time monitoring, and although the prior technologies can detect structural defects, they cannot be effectively applied to quantitative concentration analysis. In contrast, the present invention measures a plurality of characteristic signals based on the emission electromagnetic wave and the receiving electromagnetic waves, and analyzes the plurality of characteristic signals to determine the concentration characteristic of the material. Because the electromagnetic waves employed in the present invention have penetrability for many materials, they can detect optical coefficients, electrical properties, layer thickness, or structural defects for different materials and structures, and can also be used for technical inspection in manufacturing processes and inspection of semi-finished or finished products. Therefore, the present invention can realize non-contact and non-destructive concentration detection for various material types while maintaining the integrity of the material and preventing further expansion of damage or defects. In addition, the present invention can also integrate C-Scan/B-Scan scanning as disclosed in U.S. Patent Application No. 18/813,045 or the layered detection of Application No. 18/885,738 to achieve higher-resolution concentration analysis in multilayer structures or in the depth direction. The present invention is applicable to fields such as real-time process monitoring, semi-finished/finished product quality inspection, powder mixing uniformity evaluation, liquid solution concentration gradient detection, and gas component distribution monitoring. Therefore, the present invention can effectively improve the sensitivity, speed, and reliability of material concentration detection and provides an efficient and non-intrusive innovative solution for materials science, chemical engineering processes, and quality control.

In summary, the present invention provides a material concentration detection method and system that utilizes electromagnetic waves in the frequency range between 10¹⁰ Hz and 10¹⁴ Hz (including the terahertz band) to realize non-contact and non-destructive concentration detection for various material types such as solids, powders, liquids, and gases.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A material concentration detection method, comprising:
generating an emission electromagnetic wave and directing the emission electromagnetic wave to be incident upon a material, wherein the material comprises at least one of a solid, a powder, a liquid, or a gas;
detecting a plurality of receiving electromagnetic waves reflected, transmitted, or scattered after the emission electromagnetic wave is incident upon the material;
measuring a plurality of characteristic signals based on the emission electromagnetic wave and the plurality of receiving electromagnetic waves; and
analyzing the plurality of characteristic signals to determine a concentration characteristic of the material;
wherein the step of analyzing the plurality of characteristic signals comprises utilizing intensity attenuation or absorption characteristics in the plurality of characteristic signals to calculate the concentration characteristic according to the Beer-Lambert law or an analogous form of the Beer-Lambert law in a reflection or scattering mode.

2. The material concentration detection method of claim 1, wherein a frequency of the emission electromagnetic wave is between 10¹⁰ Hz and 10¹⁴ Hz.

3. The material concentration detection method of claim 1, wherein the plurality of characteristic signals comprise an electric field intensity and an electric field phase of each of the plurality of receiving electromagnetic waves.

4. The material concentration detection method of claim 3, wherein the plurality of characteristic signals further comprise at least one spectral electric field between the plurality of receiving electromagnetic waves, and each spectral electric field comprises an electric field amplitude and an electric field phase.

5. The material concentration detection method of claim 1, wherein the plurality of characteristic signals further comprise a time of flight of the plurality of receiving electromagnetic waves, and the material concentration detection method further comprises analyzing the time of flight to determine a thickness of the material.

6. The material concentration detection method of claim 1, further comprising analyzing the plurality of characteristic signals to determine at least one of a refractive index, an absorption coefficient, a scattering coefficient, a dielectric constant, or a conductivity of the material.

7. The material concentration detection method of claim 1, further comprising generating a concentration distribution map of the material according to the concentration characteristic to determine a uniformity or a local defect of the material.

8. The material concentration detection method of claim 1, wherein the material is a multilayer structure, and the material concentration detection method further comprises dividing the material into a plurality of parallel layers along a first direction and determining the concentration characteristic of each of the plurality of parallel layers.

9. The material concentration detection method of claim 1, wherein the material is at least one of a powder mixture, a solid sample, a liquid sample, or a gas sample, and the concentration characteristic comprises at least one of a moisture content, a component ratio, or an impurity concentration.

10. The material concentration detection method of claim 1, wherein the material constitutes a composite structure, the composite structure comprises a plurality of interface layers, and the material concentration detection method further comprises:
performing a C-Scan planar scan or a B-Scan cross-sectional scan on the composite structure, so that when the plurality of characteristic signals show a measurement result of signal discontinuity occurring at one interface layer of the plurality of interface layers, a structural abnormality of the interface layer is determined;
wherein determining the structural abnormality of the interface layer is based on the result of the C-Scan planar scan or the B-Scan cross-sectional scan showing that a time-domain time-of-flight spectrum signal corresponding to the interface layer has a measurement result of signal discontinuity.

11. A material concentration detection system, comprising:
an electromagnetic wave generator, configured to generate an emission electromagnetic wave and direct the emission electromagnetic wave to be incident upon a material, wherein the material comprises at least one of a solid, a powder, a liquid, or a gas;
an electromagnetic wave receiver, configured to detect a plurality of receiving electromagnetic waves reflected, transmitted, or scattered after the emission electromagnetic wave is incident upon the material; and
a detection device, coupled to the electromagnetic wave generator and the electromagnetic wave receiver, configured to measure a plurality of characteristic signals based on the emission electromagnetic wave and the plurality of receiving electromagnetic waves, and to analyze the plurality of characteristic signals to determine a concentration characteristic of the material;
wherein the step of analyzing the plurality of characteristic signals comprises utilizing intensity attenuation or absorption characteristics in the plurality of characteristic signals to calculate the concentration characteristic according to the Beer-Lambert law or an analogous form of the Beer-Lambert law in a reflection or scattering mode.

12. The material concentration detection system of claim 11, wherein a frequency of the emission electromagnetic wave is between 10¹⁰ Hz and 10¹⁴ Hz.

13. The material concentration detection system of claim 11, wherein the plurality of characteristic signals comprise an electric field intensity and an electric field phase of each of the plurality of receiving electromagnetic waves.

14. The material concentration detection system of claim 13, wherein the plurality of characteristic signals further comprise at least one spectral electric field between the plurality of receiving electromagnetic waves, and each spectral electric field comprises an electric field amplitude and an electric field phase.

15. The material concentration detection system of claim 11, wherein the plurality of characteristic signals further comprise a time of flight of the plurality of receiving electromagnetic waves, and the detection device is further configured to analyze the time of flight to determine a thickness of the material.

16. The material concentration detection system of claim 11, wherein the detection device is further configured to analyze the plurality of characteristic signals to determine at least one of a refractive index, an absorption coefficient, a scattering coefficient, a dielectric constant, or a conductivity of the material.

17. The material concentration detection system of claim 11, wherein the detection device is further configured to generate a concentration distribution map of the material according to the concentration characteristic to determine a uniformity or a local defect of the material.

18. The material concentration detection system of claim 11, wherein the material is a multilayer structure, and the detection device is further configured to divide the material into a plurality of parallel layers along a first direction and determine the concentration characteristic of each of the plurality of parallel layers.

19. The material concentration detection system of claim 11, wherein the material is at least one of a powder mixture, a solid sample, a liquid sample, or a gas sample, and the concentration characteristic comprises at least one of a moisture content, a component ratio, or an impurity concentration.

20. The material concentration detection system of claim 11, wherein the material constitutes a composite structure, the composite structure comprises a plurality of interface layers, and the detection device is further configured to:
perform a C-Scan planar scan or a B-Scan cross-sectional scan on the composite structure, so that when the plurality of characteristic signals show a measurement result of signal discontinuity occurring at one interface layer of the plurality of interface layers, a structural abnormality of the interface layer is determined;
wherein determining the structural abnormality of the interface layer is based on the result of the C-Scan planar scan or the B-Scan cross-sectional scan showing that a time-domain time-of-flight spectrum signal corresponding to the interface layer has a measurement result of signal discontinuity.
